(19) United States
(12) Patent Application Publication
(10) Pub. No.: US 2012/0080006 A1
(43) Pub. Date: Apr. 5, 2012

(54) ROTARY MODULATION ENGINE

(76) Inventor: Chun-Chiang Yeh, New Taipei City (TW)

(21) Appl. No.: 13/241,030

(22) Filed: Sep. 22, 2011

(30) Foreign Application Priority Data
Oct. 4, 2010 (TW) 099133636

(51) Int. Cl. F02B 53/00

(52) U.S. Cl. 123/246

(57) ABSTRACT

A rotary modulation engine enabling modulation of rotary pistons' rotational speeds is introduced. The rotary modulation engine utilizes four elliptical gears to drive two rotors that overlap each other with rotary pistons thereon alternating one another and rotating in the same direction. The elliptical gears also modulate the relative rotational speeds of these rotary pistons to thereby complete compression, power, exhaust and intake strokes four times in one revolution of a power output shaft of the engine. The rotary modulation engine with the above arrangements has smaller volume and improved efficiency as compared to the conventional four-stroke engine that requires two revolutions of the engine's crankshaft to complete four strokes. The rotary modulation engine can be applied to cars, ships, power generators and the like, and has reduced number of parts, volume and manufacturing cost while provides effectively upgraded operation efficiency.

### CROSS-REFERENCE TO RELATED APPLICATION

This non-provisional application claims priority under 35 U.S.C. §119(a) on Patent Application No(s). 099133636 filed in Taiwan, R.O.C. on Oct. 4, 2010, the entire contents of which are hereby incorporated by reference.

### FIELD OF THE INVENTION

The present invention relates to an internal combustion engine, and more particularly to a machine that converts thermal energy produced by an air-fuel mixture into kinetic energy.

### BACKGROUND OF THE INVENTION

While a four-stroke piston engine is the currently most representative engine type, it has a large number of complicated parts and is bulky and heavy, and these disadvantages result in low efficiency and performance of the four-stroke piston engine. The Wankel engine was developed at a later time and has an eccentric shaft, with one rotation of which two times of ignition can take place. However, the problems of air pollution, cylinder wall wear, and piston air-tightness still exist in the Wankel engine and are not effectively improved. That is, while the Wankel engine has much less parts than the four-stroke piston engine, it still has some drawbacks. As to a Diesel engine, it provides relatively good performance but is still a type of four-stroke piston engine and similarly has the disadvantages of having a large number of parts and being bulky and heavy. In brief, there are still many aspects of the currently available engine techniques that require further improvements.

### SUMMARY OF THE INVENTION

A primary object of the present invention is to provide a rotary modulation engine, so as to improve and simplify the conventional four-stroke engine, which has complicated parts and low mechanical efficiency, via a first and a second transmission mechanism that are linked to each other via four elliptical gears. The four elliptical gears control the relative rotational speeds of two rotors to thereby modulate four angular spaces in the first transmission mechanism for completing intake, compression, power and exhaust strokes. Thus, the rotary modulation engine has less parts, smaller volume, reduced manufacturing cost, and effectively upgraded operation efficiency compared to the conventional four-stroke engine.

To achieve the above and other objects, the rotary modulation engine according to the present invention includes a first transmission mechanism, a second transmission mechanism, a plug, an intake manifold, and an exhaust manifold. The first transmission mechanism includes a housing, two rotors, and a first and a second elliptical gear. The housing is assembled from a cylindrical outside cylinder wall and an outside cylinder cover. The outside cylinder wall is provided at predetermined positions with an intake port and an exhaust port, and the housing is provided at two axially opposite ends with two corresponding through holes. The two rotors are fitted and enclosed in the housing and respectively include a shaft, a circular inside cylinder, and two rotary pistons. On each of the two rotors, the shaft is extended through a center of the inside cylinder, and the two rotary pistons are externally located at two diametrically opposite ends of the inside cylinder. The two rotors are assembled together to overlap each other with the rotary pistons on one rotor alternating with the rotary pistons on the other rotor, so that an angle is contained between any two adjacent ones of the rotary pistons. The two shafts of the rotors respectively have an inner end that are rotatably connected to each other, and an outer end that are extended through the two through hole formed on the housing. The first and the second elliptical gear are fixedly connected to the outer ends of the two shafts of the rotors to locate at two axially opposite outsides of the housing. The second transmission mechanism includes a shaft, and a third and a fourth elliptical gear. The third and the fourth elliptical gear are separately fixed to two opposite ends of the shaft of the second transmission mechanism to mesh with the first and the second elliptical gear of the first transmission mechanism, respectively; and the shaft of the second transmission mechanism serves as a power output shaft. The plug is mounted on the housing at a predetermined position. The intake manifold and the exhaust manifold are connected to the intake port and the exhaust port on the housing, respectively.

With the above arrangements, the rotary modulation engine of the present invention has reduced number of parts, reduced volume, lowered manufacturing cost, and effectively upgraded operation efficiency.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1 shows the relative positions of four elliptical gears included in a rotary modulation engine of the present invention when two rotors of the engine have a maximum speed ratio between them;

FIG. 2 shows a representative design for the two rotors and rotary pistons thereof, and it can be seen the two rotors are complementary to each other in shape;

FIG. 3 shows the two rotors of FIG. 2 having been assembled to each other;

FIG. 4 shows the relative positions of the two assembled rotors of FIG. 3 when they have a maximum speed ratio between them and one of the two rotors is at its maximum rotational speed;

FIG. 5 shows one of the two rotors gradually slows down from its maximum rotational speed while the other rotor gradually speeds up from its minimum rotational speed;

FIG. 6 shows the two rotors are at the same rotational speed, and an air chamber in the engine at upper side is in a maximum compressed state, an air chamber in the engine at right side is at the end of the power stroke, an air chamber in the engine at lower side is at the end of the exhaust stroke, and an air chamber in the engine at left side is at the end of the intake stroke;

FIG. 7 shows the air chamber in the engine at upper right side is ignited to burn a compressed air-fuel mixture therein and generate power to more quickly drive the rotary piston at upper right side while the rotary piston at upper left side gradually slows down; the air chamber at lower right side is in the exhaust stroke; the air chamber at lower left side is in the intake stroke; and the air chamber at upper left side is in the compression stroke;

FIG. 8 is an exploded perspective view showing an outside cylinder wall and an outside cylinder cover forming a housing of a first transmission mechanism of the rotary modulation engine of the present invention are in a separated state and the two rotors to be enclosed in the housing are in an assembled state;

FIG. 9 is an exploded perspective view showing the connection of a plug, an intake manifold, and an exhaust manifold to the housing of the first transmission mechanism of the rotary modulation engine according to the present invention;

FIG. 10 is an assembled left side perspective view of the rotary modulation engine of the present invention;

FIG. 11 is an assembled right side perspective view of the rotary modulation engine of the present invention; and

FIG. 12 is an assembled top perspective view of the rotary modulation engine of the present invention.

### DETAILED DESCRIPTION OF THE PREFERRED EMBODIMENTS

The present invention will now be described with a preferred embodiment thereof and with reference to the accompanying drawings. It is understood the illustrated drawings are provided only for reference and easy description of the present invention and not intended to limit the present invention in any way.

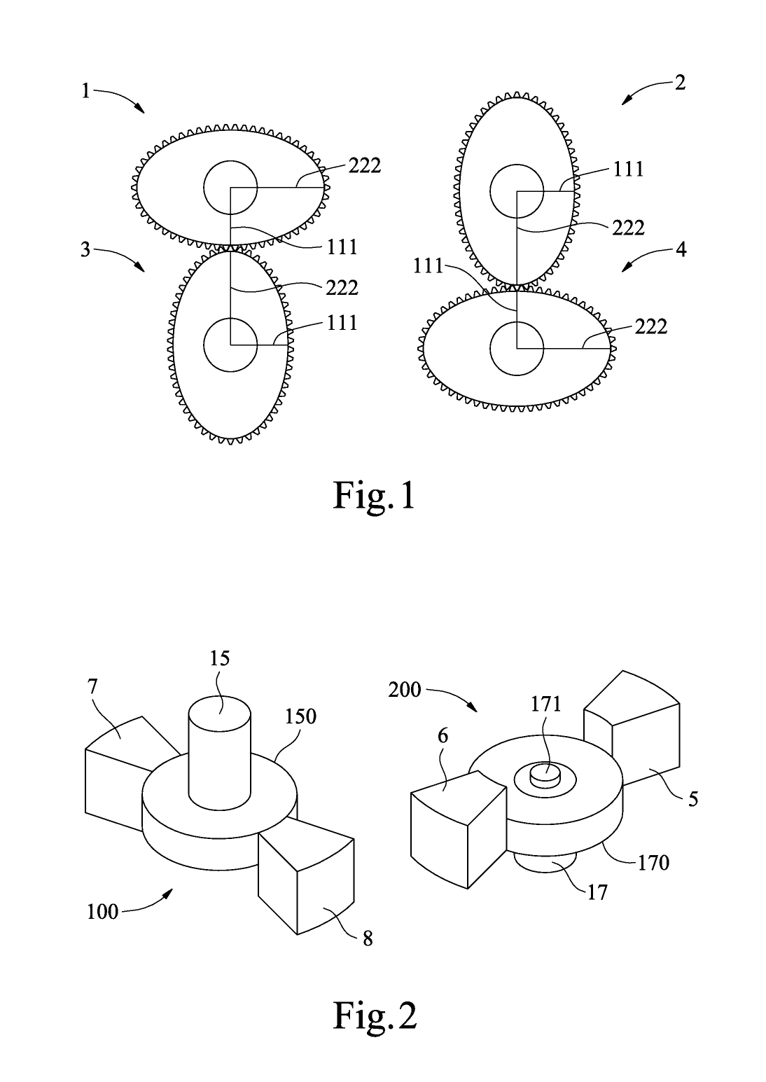

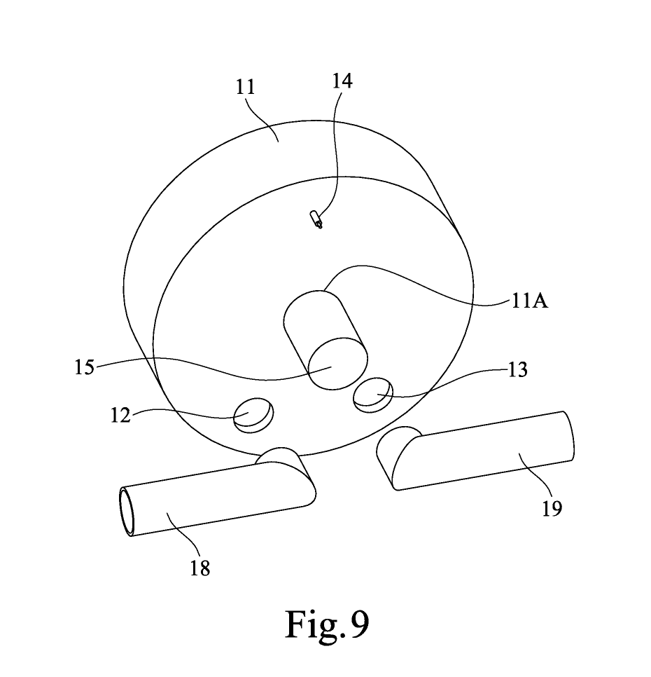

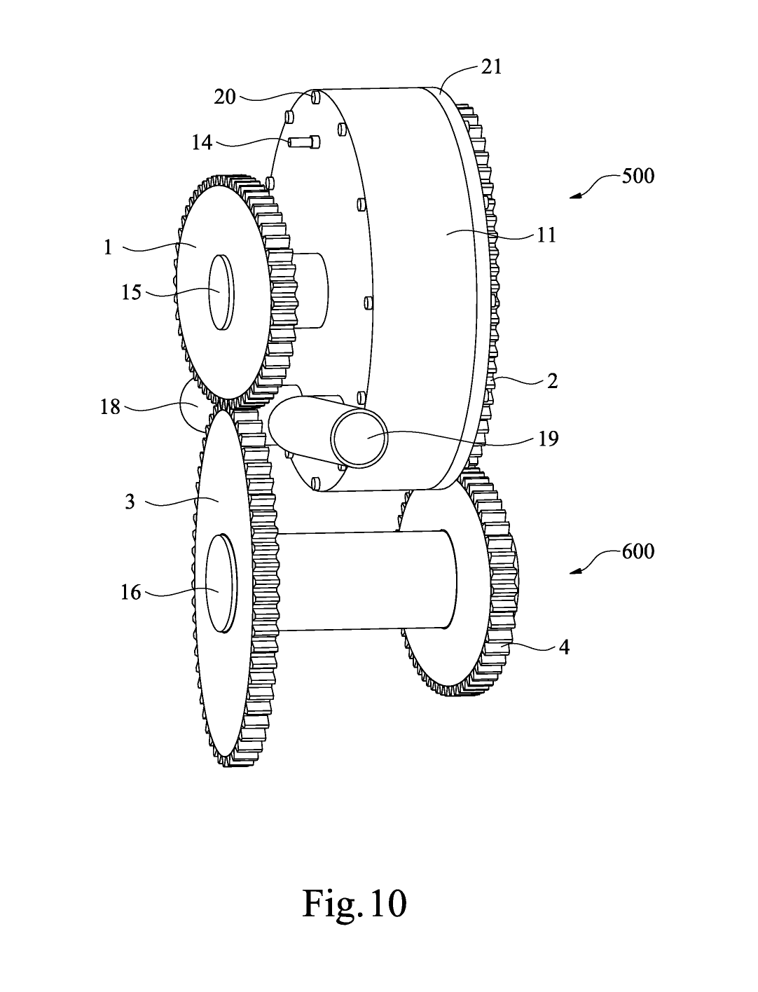

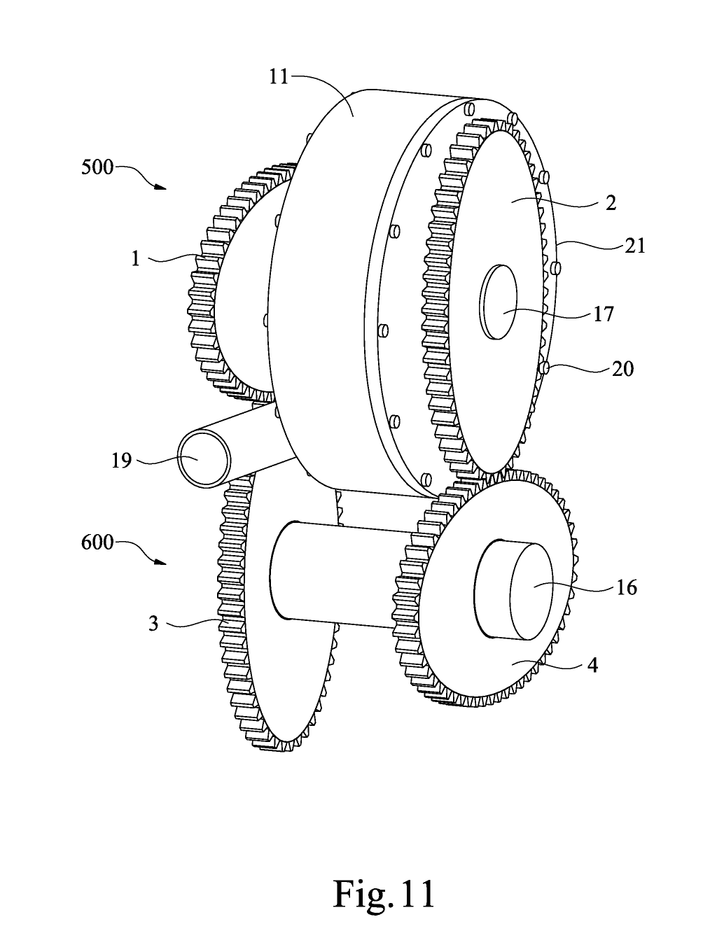

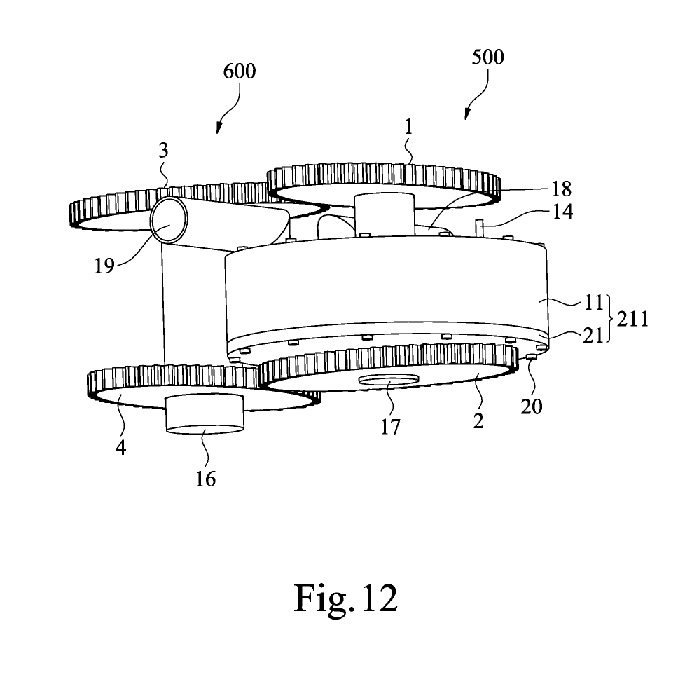

Please refer to FIGS. 1 to 12; particularly to FIGS. 10 to 12. A rotary modulation engine according to a preferred embodiment of the present invention includes a first transmission mechanism 500 and a second transmission mechanism 600. The first transmission mechanism 500 includes a housing 211; two rotors 100, 200; and two elliptical gears 1, 2. The housing 211 is formed by assembling a cylindrical outside cylinder wall 11 and an outside cylinder cover 21 to each other via a plurality of screws 20. As can be most clearly seen from FIG. 9, the outside cylinder wall 11 is provided at predetermined positions with an intake port 12 and an exhaust port 13. More specifically, the intake port 12 and the exhaust port 13 are located at lower left side and lower right side, respectively, of a flat sidewall of the outside cylinder wall 11. Further, the housing 211 is provided at predetermined positions with a through hole 11A (see FIG. 9) and a through hole 21B (see FIG. 8). Please refer to FIGS. 2, 3, and 8. The two rotors 100, 200 are fitted and enclosed in the housing 211, and respectively include a shaft 15, 17; a circular inside cylinder 150, 170; and two rotary pistons 7, 8 and 5, 6. The shafts 15, 17 are respectively extended through a center of the circular inside cylinder 150, 170; and the rotary pistons 7, 8 and 5, 6 are respectively externally located at two diametrically opposite ends of the inside cylinder 150, 170. The rotary pistons 7, 8 and 5, 6 respectively have a radially inner and a radially outer side, which are two concentric arcs. A side seal 77 is provided on all outer surfaces of each of the rotary pistons 5, 6, 7, 8 to closely contact with inner surfaces of the outside cylinder cover 21 and the outside cylinder wall 11 as well as with the inside cylinders 150, 170. The two rotors 100 and 200 in the assembled state overlap each other with the rotary pistons 7 and 8 alternating with the rotary pistons 5 and 6, so that an angle is contained between any two adjacent rotary pistons. The two shafts 15, 17 respectively have an outer end extended through the through holes 11A and 21B on the housing 211 to engage with the two elliptical gears 1, 2 outside the housing 211, respectively, as can be clearly seen in FIGS. 10 to 12. And, the two shafts 15, 17 are rotatably connected to each other at respective inner end to thereby assemble the two rotors 100, 200 to each other in the above-described manner.

The second transmission mechanism 600 includes a shaft 16 and two elliptical gears 3, 4. The two elliptical gears 3 and 4 are fixedly connected to two opposite ends of the shaft 16 in such a manner that they are meshed with the two elliptical gears 1 and 2 of the first transmission mechanism 500, respectively, with their semi-major axes extended in two orthogonal directions. More specifically, the elliptical gear 1 is meshed with the elliptical gear 3, and the elliptical gear 2 is meshed with the elliptical gear 4. The shaft 16 of the second transmission mechanism 600 serves as a power output shaft of the rotary modulation engine of the present invention.

The plug 14 is fitted on the outside cylinder wall 11 of the housing 211 and functions to ignite and accordingly start the engine.

An intake manifold 18 and an exhaust manifold 19 are connected to the intake port 12 and the exhaust port 13, respectively, which are provided on the outside cylinder wall 11.

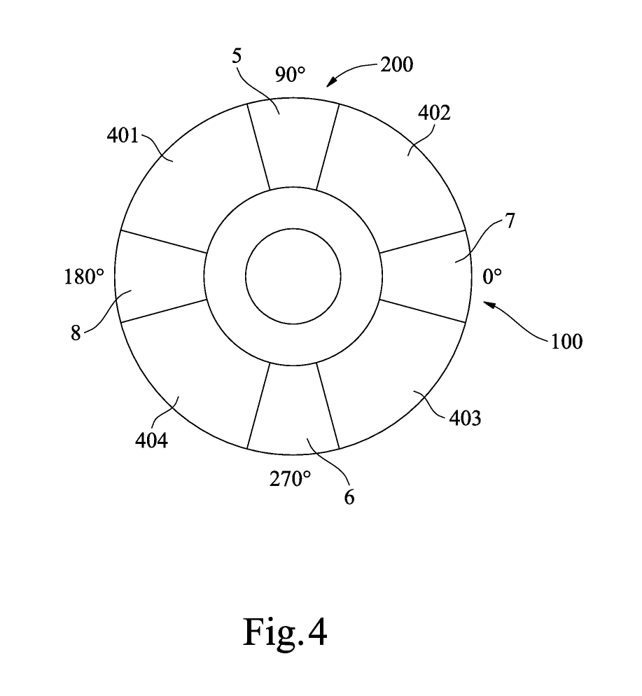

Please refer to FIG. 4 along with FIG. 1. When the two rotors 100 and 200 rotate to the positions as shown in FIG. 4, the elliptical gear 3 meshes with the elliptical gear 1 while the semi-major axis 222 of the elliptical gear 3 is aligned with a semi-minor axis 111 of the elliptical gear 1, and the elliptical gear 2 meshes with the elliptical gear 4 while a semi-major axis 222 of the elliptical gear 2 is aligned with a semi-minor axis 111 of the elliptical gear 4, as shown in FIG. 1.

As can be seen from FIGS. 1 and 10, the elliptical gear 3 and the elliptical gear 4 of the second transmission mechanism 600 are separately connected to two opposite ends of the shaft 16 with the semi-minor axis 111 of the elliptical gear 3 aligned with the semi-major axis 222 of the elliptical gear 4.

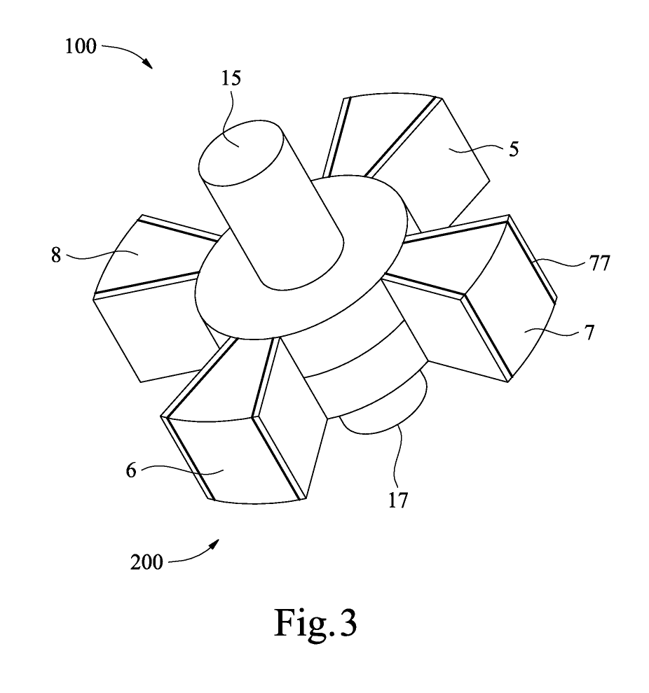

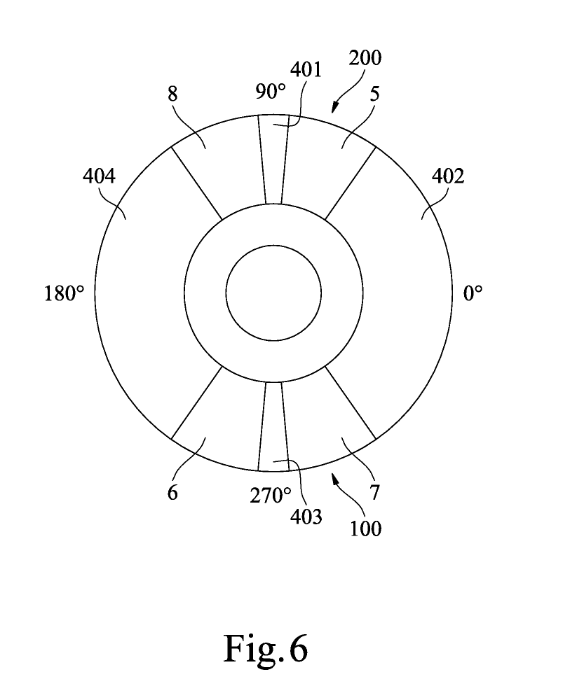

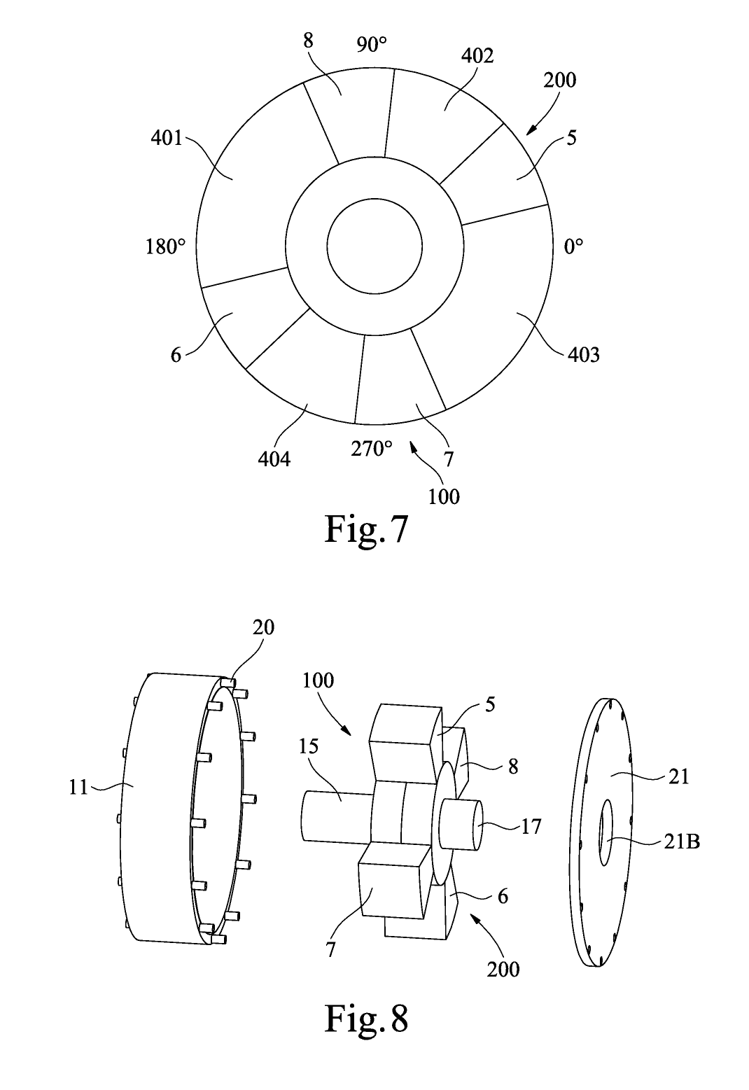

According to the structural principle of the rotary modulation engine of the present invention, two overlapped and angularly offset rotors 100, 200 are included, and four elliptical gears 1, 2, 3, 4 are used to drive and modulate the relative rotational speeds of the two rotors 100, 200, so that four angular spaces, that is, four air chambers 401, 402, 403, 404 as indicated in FIGS. 4 to 7, respectively formed between two adjacent ones of the rotary pistons 5, 6, 7, 8 of the two rotors 100, 200 are changed in volume. The rotors 100, 200 rotate along the inner surface of the outside cylinder wall 11 in the same direction. Please refer to FIG. 2. The rotor 100 includes a left rotary piston 7, a right rotary piston 8, and an inside cylinder 150. The rotor 200 includes a left rotary piston 6, a right rotary piston 5, an inside cylinder 170, and a flange shaft 171. The shaft 15 of the rotor 100 is provided at the inner end with a recess for rotatably engaging with the flange shaft 171 of the rotor 200. As shown in FIG. 8, the two rotors 100, 200 are assembled to each other and then associated with and enclosed in between the outside cylinder wall 11 and the outside cylinder cover 21. The inside cylinder 150 and the inside cylinder 170 respectively have an axial width that occupies one half of an overall axial width of the outside cylinder wall 11, such that the assembled inside cylinders 150, 170 together form a complete inside cylinder in the housing 211. The assembled rotors 100, 200 together define four closed but variable angular spaces in the housing 211, in which the intake, compression, power, and exhaust strokes take place. The rotary pistons 7, 8 and 5, 6 are located between the outside cylinder wall 11 and the outside cylinder cover 21 to rotate along the inner surface of the outside cylinder wall 11 in the same direction. As having been mentioned with reference to FIG. 3, the rotary pistons 7, 8 and 5, 6 are provided on their outer surfaces with side seals 77, which are in close contact with the inner surfaces of the outside cylinder cover 21 and the outside cylinder wall 11 as well as with the inside cylinders 150, 170. The rotors 100, 200 respectively have a rotational speed being modulated and controlled by the four elliptical gears 1, 2, 3, and 4. In the case the two rotors 100, 200 rotate clockwise and it is assumed a ratio of the semi-major axes 222 to the semi-minor axes 111 of the elliptical gears is 3:1, then the four elliptical gears 1, 2, 3, and 4 have a maximum speed ratio of 9:1. Since two meshed elliptical gears in rotation would cause changes in the distance between the semi-major axis of one elliptical gear and the semi-minor axis of the other elliptical gear, these elliptical gears actually act as a gear box that makes sinusoidal speed adjustments according to rotation angles. In the case the shaft 16 has a constant relative rotational speed of 1, the rotor 100 at the position as indicated in FIG. 4 reaches its maximum rotational speed with a relative modulation speed of 3; meanwhile, the rotor 200 at the position as indicated in FIG. 4 is at its minimum rotational speed with a relative modulation speed of ⅓, i.e. 0.33 times of its rotational speed. The rotational speed of the rotor 100 changes with the rotation of the elliptical gears 1, 3 from its maximum speed to its minimum speed according to the sinusoidal wave amplitude oscillation parameter and then gradually increases to its maximum rotational speed again; and such change in the rotor's rotational speed cycles again and again. Similarly, the rotational speed of the rotor 200 is also modulated by the rotation of the elliptical gears 2, 4. However, the modulation of the rotational speed of the two rotors occurs alternately. That is, one of the two rotors 100, 200 reaches its maximum rotational speed while the other rotor is at its minimum rotational speed. With proper planning, the two rotors 100, 200 rotating in the same direction would not collide with each other at their rotary pistons. When the two rotors 100, 200 rotate at the same speed, they have the same torque about the shaft 16. Please refer to FIG. 6, in which it is indicated the air chamber 401 is now in the compression stroke and in a maximum compression ratio, the air chamber 402 is in the power stroke, the air chamber 403 is in the exhaust stroke, and the air chamber 404 is in the intake stroke. At this point, the rotors 100, 200 keep rotating due to sluggishness or rotational inertia of the engine. Then, the air chamber 401 is ignited by the plug 14 to cause combustion of compressed air-fuel mixture therein. The rotary piston 5 is driven by a resulting high pressure from the combustion of the compressed air-fuel mixture and moves at a gradually increased speed; the high-pressure air-fuel mixture moves from the air chamber 401 into the power stroke in the air chamber 402, and the rotary piston 5 moves to the position at 0° and reaches its maximum rotational speed. Meanwhile, the rotary piston 8 moves to the position at 90° and reaches its minimum rotational speed. As shown in FIG. 6, when the rotary piston 8 moves to a position near the rotary piston 5, the relative rotational speed of the rotary piston 8 changes from 0.6 to 0.33 and back to 0.6 again; and when the rotary piston 5 moves to a position near the rotary piston 7, the relative rotational speed of the rotary piston 5 changes from 0.6 to 3 and back to 0.6 again. While the rotary piston 5 and the rotary piston 8 have different rotational speeds and different rotation angles, they take the same time to rotate. This is because the moment of force (τ) is the product of force (F) and moment arm (r); i.e., τ=F×r. The moment of force is also referred to as torque. When a gear having a larger radius works with a gear having a smaller radius, it would require less effort if the smaller gear acts as a driving gear. On the contrary, more effort is required if the larger gear acts as a driving gear to drive the smaller gear to rotate. The larger gear has a moment arm r1 longer than a moment arm r2 of the smaller gear. The same compressed air-fuel mixture applies equal push force F to the rotary piston 8 and the rotary piston 5. Therefore, when r1 is larger than r2 (r1>r2), it is obvious F×r1>F×r2. So long as the push force is the same, a moment arm ratio can also be considered as a torque ratio. However, since the pressure from the compressed air-fuel mixture in the air chamber changes with the rotation angles of the rotary pistons, a relative torque of the rotary pistons on the shaft 16 is the product of an instantaneous air-fuel mixture pressure and a relative moment arm, and an instantaneous relative major to minor axis ratio of the two pairs of elliptical gears respectively connected to the shaft 16 and the two rotors 100, 200 can be considered as a relative moment arm ratio. Please refer to FIG. 7. When the relative rotational speed of the rotary piston 8 reaches 0.4, the relative rotational speed of the rotary piston 5 also reaches 1.2. At this point, the relative moment arm of the rotary piston 5 to the shaft 16 is 1.2 while the relative moment arm of the rotary piston 8 to the shaft 16 is 0.4; and the ratio of the relative moment arm of the rotary piston 5 to that of the rotary piston 8 is 3:1. That is, a driving resistance of the rotary piston 8 against the high-pressure air-fuel mixture is three times as high as that of the rotary piston 5, such that the rotary piston 5 is driven forward by the high-pressure air-fuel mixture and provides ⅓ of its torque, which is fed back to the rotary piston 8 via the shaft 16, so that the rotary piston 8 is forced to rotate in the same direction as the rotary piston 5 and the high-pressure air-fuel mixture in the air chamber 402 has a rising pressure again. The increased pressure in turn drives the rotary piston 5 forward. Theoretically, the rotary piston 8 does not cause any kinetic loss during the whole process. Even if there is any practical friction loss, it is, however, very small. In addition, the rotary piston 5 also provides ⅔ of its toque to the shaft 16. Since the volume of the air chamber 402 at this moment does not increase too much, the pressure of the air-fuel mixture in the air chamber 402 is still high to provide good power output, even if the rotary piston 8 has already moved to the position at 90° while the rotary piston 5 keeps moving to the position of 0°. The above conditions are now described with the reference configuration shown in FIG. 4. According to FIG. 4, a ratio of the relative rotational speed of the rotor 100 to that of the rotor 200 is 3:0.33; or alternatively, the ratio of the relative moment arm of the rotary piston 7 to that of the rotary piston 5 is 9:1. That is, the relative torque of the rotary piston 7 on the shaft 16 is nine times as high as that of the rotary piston 5 on the shaft 16, and the speed ratio of the rotor 200 to the rotor 100 is 9:1. Kinetic force is transmitted from the rotary piston 7 to the shaft 16 via the elliptical gear 1 and the elliptical gear 3 while part of the kinetic energy is transmitted via the elliptical gear 4 to the elliptical gear 2, so that the elliptical gear 2 drives the rotor 200 to rotate clockwise. Since the rotary piston 5 more or less compresses the high-pressure air-fuel mixture in the air chamber 402, the pressure in the air chamber 402 correspondingly rises by some degree. The increased pressure in turn applies force on the rotary piston 7. Thus, the rotary piston 5 theoretically does not lose any energy. However, the air chamber 402 at this moment has a volume that has already reached one half of a displacement of the engine and the power output thereof is somewhat reduced. The relative torque of the rotary piston 7 and the pressure of the air-fuel mixture will reduce gradually when the rotary piston 7 moves beyond the position at 0°. When the rotary piston 7 approaches to the position at 270°, at where the exhaust port 13 is provided, the exhaust stroke begins.

During the power stroke, the rotary pistons of one of the two rotors are driven by the high-pressure air-fuel mixture to rotate in a certain direction, and the kinetic force is modulated and lowered by the two elliptical gears connected to the rotor before being transmitted to the shaft 16 of the second transmission mechanism 600. The kinetic force is then further modulated and lowered via the other two elliptical gears connected to another end of the shaft 16 and then transmitted to the other rotor that is connected to the other two elliptical gears, so that the other rotor is driven to rotate in the same direction as the first rotor. Meanwhile, the rotary pistons on the other rotor compress the high-pressure air-fuel mixture again. This is the basic principle based on which the rotary modulation engine of the present invention brings the two rotors thereof to rotate in the same direction.

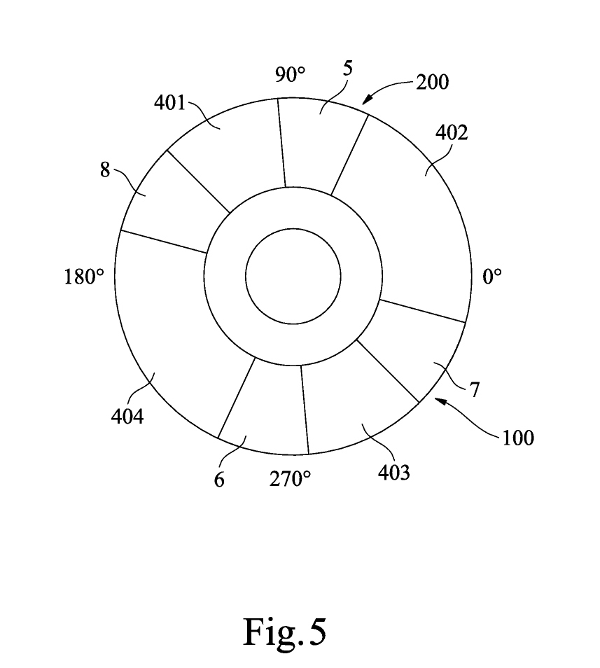

Two paired elliptical gears work just like what is described by the lever theorem. During rotation, the constantly changing major to minor axis ratio of the two paired elliptical gears functions just like a constantly changing fulcrum, and the major to minor axis ratio is also like the moment arm ratio. At any rotation angle, the push force from the compressed air-fuel mixture pressure against two circumferentially spaced rotary pistons is the same. The rotary piston with a larger moment arm would give the shaft 16 a relatively larger torque to drive the other rotary piston with a smaller moment arm. That is why the rotary piston with a smaller moment arm can easily compress the high-pressure air-fuel mixture. FIG. 5 indicates the rotor 100 gradually slows down from its maximum rotational speed while the rotor 200 gradually speeds up from its minimum rotational speed. At this point, the air chamber 401 and the air chamber 403 gradually reduce in volume of space while the air chamber 402 and the air chamber 404 gradually expand in volume of space. Each of the four strokes, namely, exhaust, intake, compression and power strokes, can take place four times in each revolution of the shaft 16. On the other hand, four power or four exhaust strokes can take place during two revolutions of a four-cylinder four-stroke piston engine's crankshaft. In the case it is assumed the two types of engines both have a single-cylinder displacement of 400 cc, then both of them have a total displacement of 1600 cc. However, the four-cylinder four-stroke piston engine has to double its rotational speed to obtain the same horsepower as the rotary modulation engine. Therefore, the rotary modulation engine according to the present invention has power output performance superior to the conventional four-cylinder four-stroke piston engine. In addition, the rotary modulation engine of the present invention has the advantages of simple structure, smooth power output, high engine rotational speed, large horsepower, and better torque. The rotary modulation engine of the present invention adopts circular cylinder structure, which has the advantages of easy to manufacture, less air pollution, high efficiency, reduced strokes, less parts, low structural wear, and smooth rotation. Further, the outside cylinder wall 11 can be cylindrical or circular in shape while the inside cylinders 150, 170 of the rotors 100, 200 can have a shape corresponding to the inner surface of the outside cylinder wall 11.

Furthermore, the elliptical gear is one of many different types of noncircular gears. The shape of the elliptical gear changes with increase in the major to minor axis ratio thereof. With the gradually increased major to minor axis ratio, the elliptical gear gradually deviates from an elliptical shape, but it is still a noncircular gear.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A rotary modulation engine, comprising:
a first transmission mechanism including a housing, two rotors, and a first and a second elliptical gear;
the housing being assembled from a cylindrical outside cylinder wall and an outside cylinder cover, the outside cylinder wall being provided at predetermined positions with an intake port and an exhaust port, and the housing being provided at two axially opposite ends with two corresponding through holes;
the two rotors being fitted and enclosed in the housing and respectively including a shaft, a circular inside cylinder, and two rotary pistons; on each of the two rotors, the shaft being extended through a center of the inside cylinder, and the two rotary pistons being externally located at two diametrically opposite ends of the inside cylinder; and the two rotors being assembled together to overlap each other with the rotary pistons on one rotor alternating with the rotary pistons on the other rotor, so that an angle is contained between any two adjacent rotary pistons; and the two shafts respectively having an inner end that are rotatably connected to each other, and an outer end that are extended through the two through hole formed on the housing; and
the first and the second elliptical gear being fixedly connected to the outer ends of the two shafts of the rotors to locate at two opposite outsides of the housing;
a second transmission mechanism including a shaft, and a third and a fourth elliptical gear;
the third and the fourth elliptical gear being separately fixed to two opposite ends of the shaft of the second transmission mechanism to mesh with the first and the second elliptical gear of the first transmission mechanism, respectively; and
the shaft of the second transmission mechanism serving as a power output shaft;
a plug being mounted on the housing at a predetermined position; and
an intake manifold and an exhaust manifold being connected to the intake port and the exhaust port on the housing, respectively.

2. The rotary modulation engine as claimed in claim 1, wherein the third and the fourth elliptical gear of the second transmission mechanism are so arranged that their semi-major axes are extended in two orthogonal directions; whereby when the two rotors are at a maximum speed ratio between them, the first and the second elliptical gear connected to the two rotors mesh with the third and the fourth elliptical gear, respectively, with their semi-major axes being orthogonal to the semi-major axis of the third and the fourth elliptical gear, respectively.

3. The rotary modulation engine as claimed in claim 1, wherein the two rotors have relative rotational speeds being modulated by the first, the second, the third, and the fourth elliptical gear; and a maximum speed ratio between the two rotors being square times of the major to minor axis ratio of the elliptical gear.

4. The rotary modulation engine as claimed in claim 1, wherein the two rotors define four air chambers in the housing, and in each of the four air chambers, four strokes, namely, compression, power, exhaust and intake strokes, take place; such that each of the compression, power, exhaust and intake strokes takes place four times in each revolution of the shaft of the second transmission mechanism.

5. The rotary modulation engine as claimed in claim 1, wherein, in a power stroke of the engine, the rotary pistons on one of the two rotors are pushed by high-pressure air-fuel mixture to rotate in a predetermined direction, and kinetic force produced in the power stroke is modulated by the two elliptical gears connected to the rotor to a lowered rotational speed before being transmitted to the shaft of the second transmission mechanism, and the produced kinetic force is further modulated by the two elliptical gears connected to another end of the shaft of the second transmission mechanism to a further lowered rotational speed before being transmitted to the other rotor for driving the same to rotate in the same direction as the first rotor while the rotary pistons on the other rotor compress the high-pressure air-fuel mixture.
